(19) United States
(12) Patent Application Publication
(10) Pub. No.: US 2009/0181181 A1
(43) Pub. Date: Jul. 16, 2009

(54) METHOD AND DEVICE FOR POWDER COATING WOOD SUBSTRATES

(76) Inventors: Peter Hauer, Hard (AT); Werner Deuring, Bregenz (AT)

Correspondence Address: K.F. ROSS P.C., 5683 RIVERDALE AVENUE, SUITE 203 BOX 900, BRONX, NY, 10471-0900, US

(21) Appl. No.: 12/441,923

(22) PCT Filed: Aug. 14, 2007
(86) PCT No.: PCT/EP2007/007162

§ 371 Date: Mar. 19, 2009

(30) Foreign Application Priority Data
Sep. 22, 2006 (DE) 102006044959.2

(51) Int. Cl. B05D 3/02; B05B 5/00

(52) U.S. Cl. 427/493; 118/641

(57) ABSTRACT

In the powder coating of wood substrates, there is the problem that on the one hand they must not become too hot and on the other hand the coating requires a certain temperature for crosslinking. With the known methods and devices, adequate crosslinking is not ensured. The object is to overcome this disadvantage. For this purpose, the freshly sprayed wood substrates (2) are pretreated by means of brief infrared radiation in such a way that the lacquer powder adheres to the wood substrates (2) and that the surfaces of the powder layer are pre-crosslinked. Then, the surfaces of the wood substrates (2) pretreated in this way are subjected to intensive hot air treatment, wherein the average temperature of the wood substrates (2) remains below 100° C.

The invention relates to a method of powder coating a wood substrate according to the introductory clause of claim 1, as well as to an apparatus for implementing the method according to the introductory clause of claim 7.

Powder coating metal parts is already well known. In the furniture industry, for example, there is an effort to use wood substrates that are powder coated. In this connection, there was the problem at first, because of the poor electrical conductivity of wood, of applying the paint powder to the wood substrates uniformly. This problem appears to have been solved to a great extent. Furthermore, the powder layer must be melted and crosslinked. In this connection, however, the wood substrate cannot become too hot because steam bubbles are formed that can destroy the powder coating. In the case of wood fiber panels, such as MDF panels in particular, high temperature can damage the glue components and thus significantly reduce the stability of the panels.

Parts that contain wood are defined as a wood substrate, in other words solid wood, plywood, or wood fibers, for example. The wood substrate is particularly present in the form of panels.

U.S. Pat. No. 6,596,347 describes a multistep method of applying two powder coatings to substrates made of metal or plastic. The layers are crosslinked, one after the other, with infrared radiation and hot-air treatment taking place at the same time. The air speed is 0.5 to 13 m/s. The temperature of the substrate reaches 125° to 200° C. The method is not suitable for treating a wood substrate, because the temperature of the substrate is too high.

An assembly for powder coating MDF panels is known from DE 10 2005 003 802 where panels onto which powder has been sprayed are irradiated with energy emitters and subsequently treated in a circulating air oven. The supports of the energy emitters are movable. In the circulating-air oven, the air is guided vertically, in other words parallel to the main surfaces of the panels; the air speed is 1 to 5 m/s, and the treatment time is approximately 8 min. A disadvantage of the known apparatus is incomplete crosslinking, with the result of lesser stability of the paint layer.

It is the object of the invention to create a method of powder coating a wood substrate in which the paint layer is crosslinked to the greatest possible extent. It is another object to provide an apparatus for implementing the method.

This object is attained accomplished by claim 1. The freshly sprayed wood substrates are preheated by short-term infrared radiation in such a way that the paint powder just adheres to the wood substrates and the surface of the powder coating is partially crosslinked. In this connection, the major portion of the paint powder melts, so that the paint powder particles adhere to one another and to the substrate surface. Only in this way does the subsequent hot air treatment become possible. This takes place intensively, according to the invention, in other words for a short time and at very high air speeds. This brings about the result that heat is transferred to the surface of the wood substrates very quickly, and thus the required temperature in the powder layer and therefore crosslinking are achieved within the shortest possible time. The short treatment time ensures that the heat does not penetrate far into the panel, which hence is heated only relatively slightly. Because of the very high air speed, not only the main surfaces of panels, for example, but also edges and/or undercut areas, are treated intensively. As a result, special treatments for such surfaces are eliminated. Because of the short treatment times required, productivity is high.

Contrary to the belief of experts in the field, the wood substrates hang sufficiently calmly during transport, in spite of the high air speed—in other words without swinging so much that they touch one another.

A pretreatment such as that described in DE 10 2005 003 802 (grinding, flaming) only needs to be carried out for the method according to the invention, in the case of wood substrates in which the surfaces do not have the required smoothness, depending on the paint powder being used. Spraying with primer is not necessary in any case.

The same holds true analogously for the apparatus according to claim 8, where the air streams that impact the main surfaces essentially perpendicularly bring about a highly intense heat transfer.

The dependent claims relate to the advantageous embodiment of the invention.

At the high air speeds of 6 to 40 m/s, large amounts of heat can be transported to the wood substrates.

The temperature of the hot air, at 120° to 200° C., guarantees the most extensive crosslinking of the paint layer that is possible without the wood substrate becoming too hot.

The treatment time of the hot air treatment, at 100 s to 300 s, is coordinated with the temperature of the hot air.

With the treatment time of the pretreatment, at 30 s to 90 s, partial melting of the surface of the powder layer is achieved, which allows the subsequent intensive hot air treatment.

The placement of multiple nozzle chambers one behind the other allows optimal coordination between the transport speed of the wood substrates and the treatment time in the hot air treatment.

The variable adjustability of the spacing between nozzle chambers that lie opposite one another allows optimal adjustment of the spacing of the nozzle chambers from the surface of the wood substrates.

If nozzles having different nozzle bases are used, the inflow onto the wood substrates can be adapted to their configuration.

Placement of emitters in a preheater in a fishbone pattern brings about the result that areas other than the main surfaces of the wood substrates are also reached by the emitters. Thus, practically all the surfaces of the powder coating are partially melted.

The invention will be described in greater detail using the simplified drawing. Therein:

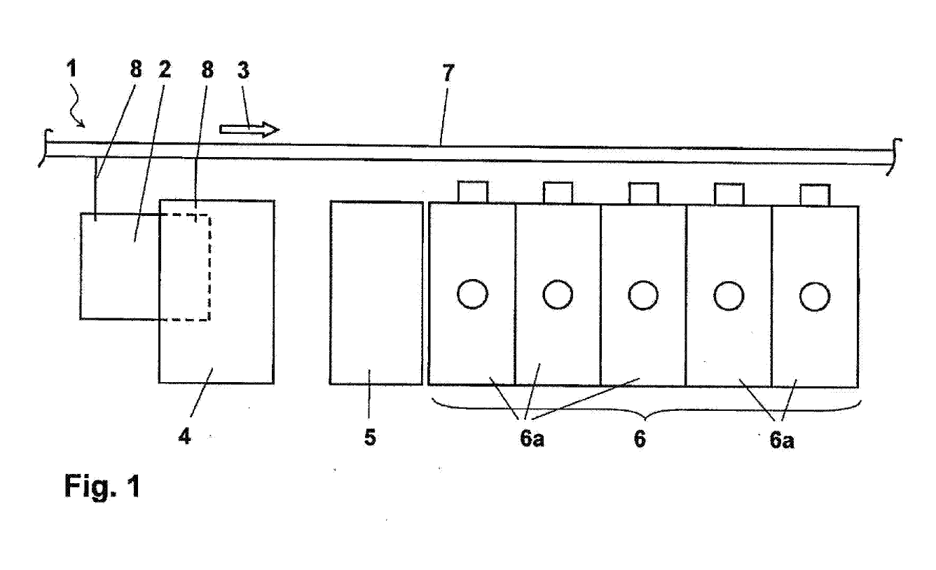

FIG. 1 is a side view of an apparatus according to the invention for powder coating a wood substrate,

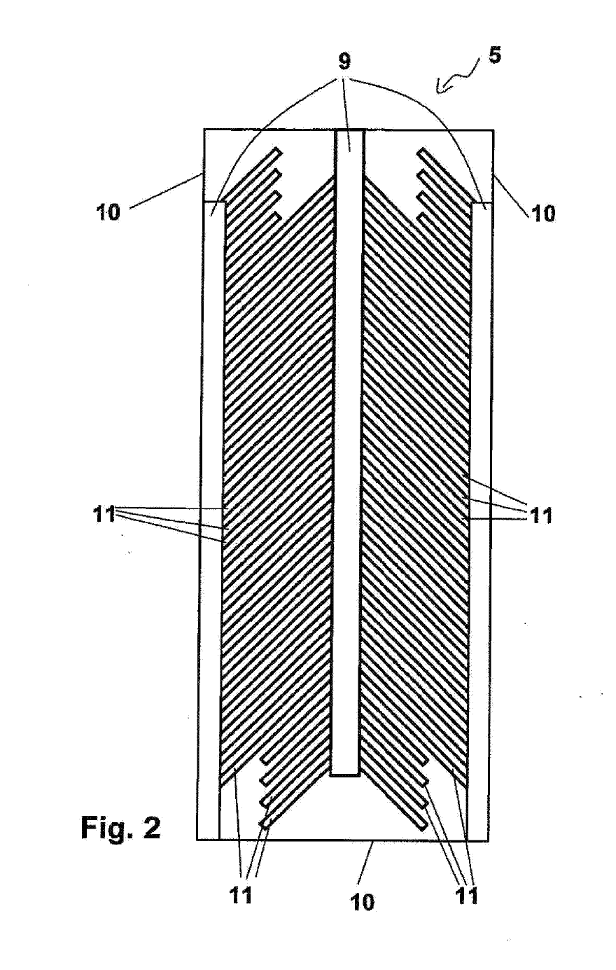

FIG. 2 shows an array of emitters in a preheater,

FIG. 3 is a view of an assembly of a nozzle chamber with another nozzle chamber that lies farther, relative to it, in the transport direction,

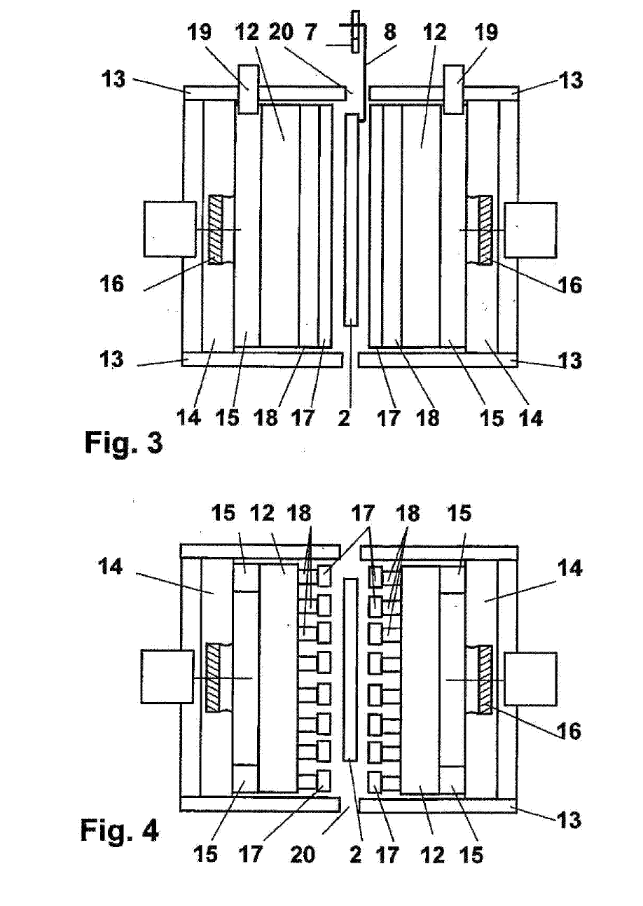

FIG. 4 is a horizontal section according to FIG. 3,

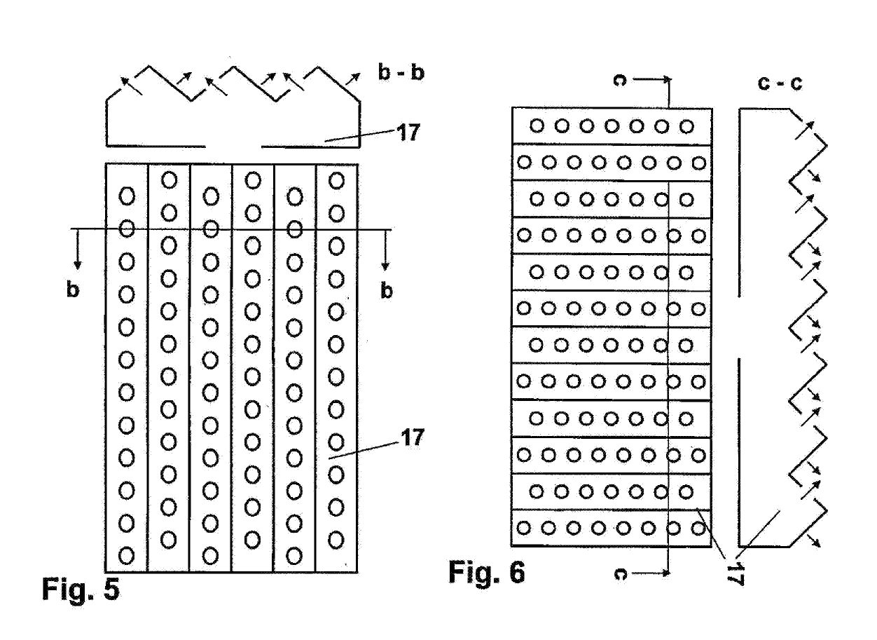

FIG. 5 is a nozzle with a zigzag lower wall, and

FIG. 6 is another nozzle having zigzag lower wall.

As is evident from FIG. 1, an apparatus for powder coating comprises a conveyor 1 on which a wood substrate 2 can be suspended for movement in a general transport direction 3 at a charging station. The conveyor 1 is an endless loop, for example. In the transport direction 3, a sprayer 4 for applying the paint powder, a preheater 5 for warming the freshly applied powder layer by means of infrared radiation, and means 6 for melting and crosslinking the preheated powder layer follow one another.

The conveyor 1 is, for example, a suspension conveyor having a rail 7 in which a circulating chain is guided. Hooks 8 can be hung from the chain at spacings that can be selected (in accordance with the size of the wood substrates).

The sprayer 4 for the paint powder is known and is supplied, for example, by the Wagner (CH Altstätten) or Nordson (DE Erkrath) companies. It is not described in greater detail here.

The preheater 5 for the freshly sprayed-on paint powder can be seen particularly well in FIG. 2, and comprises two support frames 9 that spacedly confront with their front sides. The spacing between them is variably adjustable by way of a hand wheel, for example. Each support frame 9 is surrounded on five sides by a first housing 10, and a plurality of infrared emitters 11 is attached to the front side. The infrared emitters 11 are tubular carbon emitters that are attached to the plane of the front side in a fishbone pattern. In this connection, the infrared emitters 11 are disposed in two columns, running at an angle of approximately 45° from the outside, from the bottom to the top, toward the center of the front side. At the bottom, from the center, and at the top, from the sides, infrared emitters 11 having a lesser (here, half the effective) length are attached in order to keep the area without infrared emitters as small as possible. From the sheathed ends of the complete array of the infrared emitters 11, an effective area of the preheater 5 is obtained for each side. The carbon emitters, for example Type CRS 2300 G from Heraeus, are coated with a material that reflects infrared rays, on their side that faces the housing, e.g. gold is vapor-deposited onto them. The infrared emitters 11 can be installed turned in such a manner that the radiation direction is alternately directed 45° upward and downward, for example. In order to protect the infrared emitters from overheating, forced ventilation is provided for them. In a preferred embodiment, the infrared emitters 11 can be turned on individually or in groups.

In FIGS. 3 and 4, the melting and crosslinking unit 6 is shown in greater detail. These are directly adjacent the preheater 5, and are divided into five identical fields 6a here. The five fields 6a comprise ten nozzle chambers 12 in two parallel rows. In this manner, each nozzle chamber 12 has another lying opposite it at a predetermined spacing, and each field 6a has two opposite nozzle chambers 12. The spacing between two front sides of the nozzle chambers 12 that lie opposite one another is variably adjustable.

Each nozzle chamber 12 is mounted in a machine frame 13. Each nozzle chamber 12 has a pressure chamber 14 assigned to it that is connected to it by passages 15. In each pressure chamber 14, a fan 16 is provided at an inlet, can be driven by a motor, and is mounted on the machine frame 13. At the front of each nozzle chamber 12, a plurality of parallel, vertically oriented nozzles 17, here eight, is attached. Each nozzle 17 has a flat nozzle plane having nozzle openings disposed in a pattern, and is connected with the nozzle chamber 12 by means of a respective feed line 18. A treatment space is formed between opposite nozzle planes. A burner 19 is provided as a heat source for heating circulating air, in such a manner that hot gases issue from it into the inlet of the fan 16.

The melting and crosslinking unit 6 is surrounded by a heat-insulating housing except at a slit 20 for passage of the hooks 8 and the wood substrates 2. The machine frame 13 is integrated into the housing. All or individual partition walls between two fields 6a can be insulated.

Alternatively, some or all the nozzles 17 having a flat nozzle plane, as described above, are replaced with nozzles 17 having a special nozzle plane. Two examples of this can be seen in FIGS. 5 and 6. Here, the nozzle planes are zigzag-shaped, in each instance, with the zigzag shape being formed in cross-section in the example of FIG. 5, and in the longitudinal section of the nozzle plane in the example of FIG. 6.

The effective heights of the preheater 5 and the melting and crosslinking unit 6 correspond at least to the greatest height of a wood substrate 2 to be treated when suspended from the conveyor 1. Here, the effective height is approximately 2 m.

The wood substrates 2 to be processed in the apparatus preferably have a moisture content of 7 weight-%. To this end, they are stored in a climate-controlled chamber at 50% relative humidity and a temperature of 20° C., for example, before being powder coated.

In operation, the wood substrate 2 supplied are suspended from the hooks 8 of the conveyor 1, by machine or by hand, and continuously transported in the direction of the arrow 3 by the apparatus. The wood substrates 2 first move into the sprayer 4 where all their surfaces are sprayed with a suitable paint powder in a uniform thickness; in order for the paint powder to adhere sufficiently to the wood substrates 2, the latter are electrostatically charged.

The wood substrates 2 freshly sprayed with paint powder, are then transported into the preheater 5. Here all the infrared emitters 11 are normally turned on. As a result, the powder layer is heated up in such a manner that it at least softens and adheres to the wood substrate 2 and the individual particles adhere to one another. As a result of the special arrangement of the infrared emitters 11, the secondary surfaces (top, bottom, front, and rear sides) of the wood substrates 2 are also heated sufficiently.

Immediately downstream of the preheater 5, the wood substrates 2 move into the melting and crosslinking unit 6. Here, the fans 16 are in operation and blow hot air out of the nozzles 17 onto the surfaces of the wood substrates 2; in this connection, the air has a temperature of 130° to 200° C., and an impact speed of 20 to 35 m/s. As a result of this intensive hot air treatment, the powder layer, which had previously started to melt, melts completely and is crosslinked (sintered) to the greatest possible extent, within a short time. This results in a sealed paint surface of the powder layer, with a specific smoothness, which demonstrates excellent chemical and mechanical stability.

In the melting and crosslinking unit 6, the air is circulated hot. To this end, each fan 16 draws the air out of an upper and a lower part of the treatment space, and forces it back into the treatment space onto the wood substrates 2 by way of the pressure chambers 14, the air passages 15, the nozzle chamber 12, the pressure lines 18, and the nozzles 17.

In this connection, the air stream that exits from the nozzles 17 impacts the main surfaces of the wood substrates 2 essentially perpendicular. For the nozzles 17 having a flat nozzle plane, this means that the hot air exits perpendicular to the nozzle plane, and flows to the wood substrates 2 in a straight line. In the case of the nozzles 17 having a zigzag-shaped nozzle plane, the hot air does exit from the nozzle plane at an angle of 45°, however, eddying also takes place, which brings about the result that both a related part of the main surfaces and the front, rear, top, and bottom sides are intensively treated by the hot air.

The air is heated to the desired temperature of 130° to 200° C. by the burners 19, and the temperature is kept constant by means of appropriate regulation.

If cooling of the wood substrates is necessary after crosslinking, the burners 19 of the last field 6a are turned off and the fans 16 draw ambient air in as cooling air. To this end, appropriate flaps are open. The heated cooling air passes out.

The finished coated wood substrates 2 are removed from the conveyor 1 by hand or by machine, and are transported away or placed into temporary storage.

1. A method of powder coating a wood substrate, wherein
the wood substrates are supplied and then continuously transported,
the wood substrates are sprayed with the paint powder, and
the paint powder freshly applied to the wood substrates is melted and crosslinked to produce a paint layer, characterized in that
the freshly sprayed a wood substrate are preheated by short-term infrared radiation in such a way that the paint powder just adheres to the wood substrate and the surfaces of the powder coating are precrosslinked, and
thereafter the surfaces of the wood substrates preheated in this manner are exposed to intensive hot air treatment with an average temperature of the wood substrates remaining below 100° C.

2. The method according to claim 1 wherein the hot air is directed essentially perpendicular to the surfaces of the wood substrates.

3. The method according to claim 1 that wherein the speed of the hot air at the surfaces is 6 to 40 m/s.

4. The method according to claim 1 wherein the temperature of the hot air is 130° to 200° C.

5. The method according to claim 1 wherein the treatment time of the hot air treatment is 100 s to 300 s.

6. The method according to claim 1 wherein the treatment time of the pretreatment is 30 s to 90 s.

7. An apparatus for powder coating wood substrates, having
transport means for the wood substrate,
a sprayer for applying the paint powder onto the wood substrates,
a preheater for warming the freshly applied powder layer by means of infrared emitters, and
a melting and crosslinking unit for the preheated powder layer,
wherein
the melting and crosslinking unit comprises at least one nozzle chamber, where each nozzle chamber has another lying opposite it at a predetermined spacing,
nozzles of the nozzle chambers are perpendicular and essentially parallel to one another, and
a nozzle plane of each nozzle is configured in such a manner that exiting air streams impact the main surfaces of the wood substrates essentially perpendicularly.

8. The apparatus according to claim wherein seen in the transport direction, multiple nozzle chambers are disposed one behind the other.

9. The apparatus according to claim 7 wherein a spacing between nozzle chambers that lie opposite one another is variably adjustable.

10. The apparatus according to claim 7 wherein the spacing between opposite nozzle chambers is 100 mm to 500 mm.

11. The apparatus according to claim 7 wherein nozzles having different nozzle planes are used.

12. The apparatus according to claim 7 wherein the preheater comprises a plurality of electrical, tubular infrared emitters, arrayed in a fishbone pattern.
